(19) United States
(12) Patent Application Publication
(10) Pub. No.: US 2026/0127382 A1
(43) Pub. Date: May 7, 2026

(54) LARGE LANGUAGE MODEL HALLUCINATION ATTENUATION BASED ON MULTI-AGENT DEBATE

(71) Applicant: International Business Machines Corporation, Armonk, NY (US)

(72) Inventors: Zhong Fang Yuan, Xi'an (CN); Wen Wang, Hai Dian District (CN); Tong Liu, Xi'an (CN); He Li, BEIJING (CN); Haechul Shin, Durham, NC (US)

(73) Assignee: International Business Machines Corporation, Armonk, NY (US)

(21) Appl. No.: 18/936,395

(22) Filed: Nov. 4, 2024

(51) Int. Cl. G06F 40/35

(52) U.S. Cl. CPC G06F 40/35

(57) ABSTRACT

A action-flow including one or more proposed actions derived from the response of the least one agent with the adopted personality engaged in the debate, within the personality council is determined. The selection of at least one agent and at least one critic from a group of agents and critics, based on a user's query, is performed. The construction of a personality council for the large language model (LLM) based on the user's query and at least one agent and at least one critic is performed. The conduction one or more rounds of a debate, within the personality council, among the at least one agent and at the least one critic from the group of agents and critics, wherein a response of the least one agent with the adopted personality is critiqued by the least one critic, based on the user's query, until a threshold for concluding the debate is met or exceeded, is also performed.

### BACKGROUND

The present invention relates generally to question-answer generation using large language models (LLMs). More particularly, the present invention relates to a method, system, and computer program designed for attenuating hallucinations in large language models (LLM) using an agent-based perspectives, within a debate/critic-actor framework.

One challenge, recognized by the illustrative embodiments of the invention, is that businesses must carefully consider managing hallucinations if or when they plan to deploy large language models (LLMs) in business-critical applications. Businesses generally require such business-critical applications to be reliable and robust, but large language models (LLMs) may experience hallucinations, especially when large language models (LLMs) generating complex content, such as content related to ambiguous subject matter. The embodiments of the invention further acknowledge that even when large language models (LLMs) use agents and retrieval-augmented generation (RAG), a method that theoretically improves accuracy by combining the retrieval of relevant external documents with the model's generative capabilities, hallucinations can still occur at unacceptable frequencies. For example, hallucinations can result in incorrect answers or inaccurate JavaScript Object Notation (JSON) outputs. These hallucinations may deter businesses running mission-critical applications from adopting LLMs in their infrastructure, where stable performance and interpretability are highly valued.

Additionally, as recognized by the illustrative embodiments of the invention, hallucinations may negatively affect user experiences and undermine customer trust in the mission-critical applications. When users or customers repeatedly encounter inconsistent or incorrect information, the overall confidence of the users or customers in the mission-critical application's reliability diminishes, potentially leading to customer dissatisfaction and loss of business. Ensuring that large language models (LLMs) generate reliable and accurate content and answers is useful to maintaining positive business reputations and achieving long-term success.

For example, as recognized by the illustrative embodiments of the invention, when a large language model (LLM) provides incorrect answers or erroneous data in areas like customer support, financial analysis, or decision-making tools, these incorrect answers or erroneous data may lead to flawed conclusions and operational disruptions. Businesses may suffer losses in business efficiency and weakened trust from clients and stakeholders, and possibly face legal or compliance issues if the incorrect answers or erroneous outputs lead to regulatory non-compliance or contractual breaches.

Therefore, the illustrative embodiments recognize that it would be desirable to have methods, systems, and computer programs designed for attenuating hallucinations in large language models (LLM) using an agent-based perspective within a debate/critic-actor framework.

### SUMMARY

The illustrative embodiments provide for optimizing reflective method based on multi-personality driven LLM-agents. An embodiment includes selecting at least one agent and at least one critic from a plurality of agents and critics, based on a user's query. The embodiment includes constructing a personality council for the large language model (LLM) based on the user's query and at least one agent and at least one critic from the plurality of agents and critics. The embodiment includes conducting one or more rounds of a debate, within the personality council, among at least one agent and at least one critic from the plurality of agents and critics. The embodiment includes building an action-flow comprised of one or more proposed actions derived from the response of the least one agent with the adopted personality engaged in the debate, within the personality council. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of personality workflow DAG in accordance with an illustrative embodiment;

FIG. 3 depicts a block diagram of personality warehouse prompt list construction in accordance with an illustrative embodiment;

FIG. 4 depicts a flowchart of an example of a LLM personality council construction in accordance with an illustrative embodiment; and

FIG. 5 depicts a flowchart of an example of an action-flow flow construction based on LLM personality parliament results in accordance with an illustrative embodiment;

### DETAILED DESCRIPTION

The present disclosure addresses the deficiencies recognized by the illustrative embodiments and described above by providing a process (as well as a system, method, machine-readable medium, etc.) for attenuating hallucinations in large language models (LLMs) through an agent-based approach within a debate and critic-actor framework. This approach improves the accuracy of the large language models (LLM) outputs, ensures thorough critical evaluation of responses, and produces cohesive and reliable results from the LLMs.

Providing improved functionality attenuating hallucinations in large language models (LLMs) through an agent-based approach within a debate and critic-actor framework matters for the following reasons. First, this improved functionality increases the likelihood that large language models (LLMs) generate more accurate and reliable outputs or answers, minimizing the risk of errors that may impact business decisions and operational processes. By mitigating the frequency of hallucinations, businesses may rely on large language models (LLMs) to deliver accurate and useful information to make informed choices. Second, this improved functionality (by enhancing the accuracy in large language models (LLMs) outputs or answers) contributes to better user experiences, as users receive responses that are relevant and trustworthy. This reliability and trustworthiness may engender greater confidence in customers, encouraging wider adoption of large language models (LLMs). Third, the improved functionality addresses hallucinations through such frameworks (recognized by illustrative embodiments) may facilitate compliance with regulatory standards and reduce the potential for costly legal disputes arising from erroneous or misleading information generated by large language models (LLMs). Disclosed embodiments provide advantages/benefits and technological improvements over the existing tools, techniques, and systems for reducing hallucinations in large language models (LLMs) through an agent-based approach within a debate and critic-actor framework, promoting operational integrity, user satisfaction, and legal compliance of large language models (LLM).

An illustrative overview of an embodiment of the invention is as follows: reducing hallucinations in large language models (LLMs) through an agent-based approach within a debate and critic-actor framework, generally comprises the following stages: 1) User Query, 2) Personality Selection, 3) Personality Workflow Distributed Action Generator, 4) Action Plan Stage, and 5) Large language model (LLM).

### User Query Stage

At one stage, a user's query may be received.

### Personality Selection Stage

At another stage, one or more personalities may be selected. In some embodiments, the second stage may be integrated into the first stage, functioning as a single step or a series of steps within a method.

### Personality Workflow Distributed Action Generator Stage

At another stage, the user's query may be assigned or distributed to a workflow or action plan for processing by one or more selected personalities, managed by agents or large language models (LLMs). In some embodiments, the third stage may be integrated into the first stage or the second stage, functioning as a single step or a series of steps within a method.

### Action Plan Stage

At another stage, the collaboration, interaction, or debate between by one or more selected personalities, managed by agents, critics, decision markers, or large language models (LLMs), within a workflow or action plan may be overseen or managed. In some embodiments, the fourth stage may be integrated into the first stage or the second stage or the third stage, functioning as a single step or a series of steps within a method.

### Large Language Model (LLM) Stage

At another stage, the user's query may be responded to by a large language model (LLM). In some embodiments, the fifth stage may be integrated into the first stage or the second stage or the third stage or fourth stage, functioning as a single step or a series of steps within a method. Although the five stages described above were described in a specific order, it should be understood that other stages may be performed among the five stages or may be performed in an order other than that described, or stages may be adjusted so that they occur at slightly different times.

The following description provides examples of embodiments of the present disclosure, and variations and substitutions may be made in other embodiments. Several examples will now be provided to further clarify various aspects of the present disclosure.

Example 1: A computer-implemented method for attenuating hallucinations in a large language model (LLM). The method further includes selecting at least one agent and at least one critic from a group of agents and critics, based on a user's query. The method further includes constructing a personality council for the large language model (LLM) based on the user's query and the at least one agent and at the least one critic from the group of agents and critics, where the personality council instructs the least one agent to adopt a personality. The method further includes conducting one or more rounds of a debate, within the personality council, among the at least one agent and at the least one critic from the group of agents and critics, wherein a response of the least one agent with the adopted personality is critiqued by the least one critic, based on the user's query, until a threshold for concluding the debate is met or exceeded. The method further includes building an action-flow comprised of one or more proposed actions derived from the response of the least one agent with the adopted personality engaged in the debate, within the personality council.

The above limitations enable the determination of an action-flow comprised of one or more proposed actions derived from the response of the least one agent with the adopted personality engaged in the debate. By selecting at least one agent and one critic based on the user's query, this method increases the likelihood that both the debate and evaluation are directly relevant to the specific context of the user's query, thereby enhancing the accuracy and pertinence of the responses of the large language model (LLM). Constructing a personality council with agents adopting distinct personalities promotes diverse perspectives and richer dialogue, which in turn deepen the consideration of the user's query and bolsters the reliability of the conclusions reached by the large language model (LLM). Conducting multiple rounds of debate until a predefined threshold is met ensures that responses undergo thorough scrutiny and refinement, aiding in the identification and correction of errors or hallucinations in the large language model (LLM), thereby improving overall dependability. Last, building an action-flow based on these refined responses ensures that the resulting actions are derived from a well-validated process, leading to actionable and reliable outcomes for the large language model (LLM) and end-users. Aspects of the present disclosure contribute to reducing hallucinations in large language models, resulting in more accurate and contextually appropriate outputs.

Example 2: The limitations of Example 1, further displaying an answer based the action-flow.

The above limitations advantageously facilitate displaying an answer based the action-flow. By displaying an answer derived from the “action-flow,” which is the result of a debate between the agent and critic within the personality council, this method enhances transparency and trust in the large language model's (LLM) responses. This method also reduces the likelihood of hallucinations or inaccuracies in the LLM's output, ensuring that the resulting answer presented to the user has undergone scrutiny and refinement through the debate process. Aspects of the present disclosure ensure users receive clearer, more accurate responses that directly address the queries submitted, improving the overall user experience and satisfaction.

Example 3: The limitations of Examples 2-1, where the selecting at least one agent further includes selecting three agents and the personality council instructs the three agents to adopt distinct personalities. This method ensures that a broader diversity of perspectives are engaged during the debate process, improving the analysis and quality of complex queries. With three distinct agents, the method may explore different viewpoints or strategies, increasing the depth of discussion and enhancing the likelihood of identifying potential errors, inconsistencies, or hallucinations in the large language model's (LLM) responses. Additionally, the engagement of multiple personalities may allow the method to mirror real-world decision-making processes, where varied opinions contribute to more accurate and reliable outcomes.

Example 4: The limitations of Examples 3-1, where the constructing the personality council for the large language model (LLM) is further based on a selection of at least one decision maker. The above limitations advantageously provide an important benefit by adding a governing entity responsible for moderating and finalizing decisions during the debate process. The decision maker's role ensures that the debate among the agents and critics remains focused, balanced, and moves toward an efficient resolution. By overseeing the debate process, the decision maker helps establish when a consensus or a satisfactory conclusion has been reached, especially in situations where the agents'viewpoints diverge. This inclusion of decision maker adds an extra layer of oversight, improving the quality and reliability of the LLM's outputs, while ensuring that the debate process doesn't become indefinite or circular.

Example 5: The limitations of Examples 4-1, where constructing the personality council for the large language model (LLM) further comprises: the personality council instructing the decision maker to moderate a debate. The above limitations advantageously, by designating the decision maker as the debate moderator, adds the benefit of structured oversight, ensuring the debate remains productive and goal-oriented. The decision maker actively guides the conversation, resolves conflicts, and maintains the flow of dialogue. This authorized moderation minimizes potential deadlock or inefficiency, ensures adherence to the query's context, and enforces the threshold for concluding the debate, which further enhances the accuracy, efficiency, and relevance of the final action-flow derived from the LLM.

Example 6: The limitations of Examples 5-1, where the conducting the one or more rounds of the debate, within the personality council further comprises: concluding a round of a debate when a second threshold is met or exceeded. The above limitations advantageously introduce an additional layer of control over the debate process. By incorporating a second threshold, this method ensures that each round of debate is evaluated based on predefined criteria, enabling the debate process to be stopped at a logical conclusion when the quality of the debate or response reaches a satisfactory level. This second threshold mechanism prevents excessive or unnecessary rounds of debate, streamlining the debate process and optimizing the balance between thoroughness and efficiency. Additionally, the second threshold enhances the overall reliability of the LLM's output by providing an objective measure to assess when a particular line of inquiry or critique has been sufficiently addressed, contributing to a more efficient and accurate determination of the final action-flow.

Example 7: The limitations of Examples 3-1, where the conducting the one or more rounds of the debate, within the personality council further comprises: concluding a round of a debate when a second threshold is met or exceeded. The above limitations advantageously introduce an additional layer of control over the debate process. By incorporating a second threshold, this method ensures that each round of debate is evaluated based on predefined criteria, enabling the debate process to be stopped at a logical conclusion when the quality of the debate or response reaches a satisfactory level. This second threshold mechanism prevents excessive or unnecessary rounds of debate, streamlining the debate process and optimizing the balance between thoroughness and efficiency. Additionally, the second threshold enhances the overall reliability of the LLM's output by providing an objective measure to assess when a particular line of inquiry or critique has been sufficiently addressed, contributing to a more efficient and accurate determination of the final action-flow.

Example 8: A computer usable program product comprising one or more computer readable storage media, and program instructions collectively stored on the one or more computer readable storage media to perform the method according to any of Examples 1 - 7. The computer program product of Example 8 realizes the benefits described with respect to Examples 1 - 7. The computer program product of Example 8 can advantageously be implemented into a variety of computer program products.

Example 9: The limitations according to Example 8, further including displaying an answer based the action-flow. The above limitations realize the technical advantages discussed with respect to Example 2.

Example 10: The limitations according to Example 9, where the selecting at least one agent includes selecting three agents and the personality council instructs the three agents to adopt distinct personalities. The above limitations realize the technical advantages discussed with respect to Example 3.

Example 11: The limitations according to Examples 10-8, where the constructing the personality council for the large language model (LLM) is further based on a selection of at least one decision maker. The above limitations realize the technical advantages discussed with respect to Examples 3 and 4.

Example 12: The limitations according to Examples 11-8, where constructing the personality council for the large language model (LLM) further comprises: the personality council instructing the decision maker to moderate a debate. The above limitations realize the technical advantages discussed with respect to Example 5.

Example 13: The limitations according to Examples 12-8, where the conducting the one or more rounds of the debate, within the personality council further comprises: concluding a round of a debate when a second threshold is met or exceeded. The above limitations realize the technical advantages discussed with respect to Example 6.

Example 14: The limitations according to Example 10 - 8, where the conducting the one or more rounds of the debate, within the personality council further comprises: concluding a round of the debate when a second threshold is met or exceeded. The above limitations realize the technical advantages discussed with respect to Example 7.

Example 15: A system comprising one or more processors and one or more computer-readable storage media collectively storing program instructions which, when executed by the one or more processors, are configured to cause the one or more processors to perform the method according to any of Examples 1 - 7. The system of Example 15 realizes the benefits described with respect to Examples 1 - 7. The system of Example 15 can advantageously be implemented into a variety of computing devices.

Example 16: The limitations according to Example 15, further including displaying an answer based the action-flow. The above limitations realize the technical advantages discussed with respect to Example 2.

Example 17: The limitations according to Examples 16-15, where the selecting at least one agent includes selecting three agents and the personality council instructs the three agents to adopt distinct personalities. The above limitations realize the technical advantages discussed with respect to Example 3.

Example 18: The limitations according to Examples 17-15, where the constructing the personality council for the large language model (LLM) is further based on a selection of at least one decision maker. The above limitations realize the technical advantages discussed with respect to Examples 3 and 4.

Example 19: The limitations according to Examples 18-15, where constructing the personality council for the large language model (LLM) further comprises: the personality council instructing the decision maker to moderate a debate. The above limitations realize the technical advantages discussed with respect to Example 5.

Example 20: The limitations according to Examples 19-15, where the conducting the one or more rounds of the debate, within the personality council further comprises: concluding a round of a debate when a second threshold is met or exceeded. The above limitations realize the technical advantages discussed with respect to Example 6.

Aspects of the present disclosure can be implemented in a variety of technical use cases. The following use cases are merely exemplary and are not intended to limit the scope of the disclosure.

In a first use case: the methods disclosed may be employed to improve the accuracy and relevance of automated responses generated by an LLM in customer support or service context. By selecting specific agents and critics based on the nature of customer inquiries, the LLM's responses are evaluated through a personality council that includes diverse perspectives and expertise. For instance, if a customer query relates to a complex technical issue (e.g., computer hardware repair), agents with technical expertise and critics knowledgeable in troubleshooting (e.g., computer hardware) are chosen. The debate process within the personality council increases the likelihood that responses to the complex technical issue are thoroughly scrutinized and refined before finalizing the answer or action-flow. This iterative process helps in generating more precise and contextually appropriate answers, leading to higher customer satisfaction and reduced incidence of misinformation.

In a second use case: particularly in the financial analysis context, the methods disclosed may be used to enhance the reliability of insights and recommendations provided by an LLM. For example, when analyzing market trends or providing investment advice, the methods select agents and critics with relevant financial expertise and perspectives. The personality council is constructed to include these experts who debate and critique the LLM's responses based on current market data and financial criteria. The debate process continues until the responses meet a predefined threshold of accuracy and relevance. This evaluation verifies that the final recommendations are well-informed and dependable, which is useful for investors and financial analysts seeking accurate guidance for decision-making.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

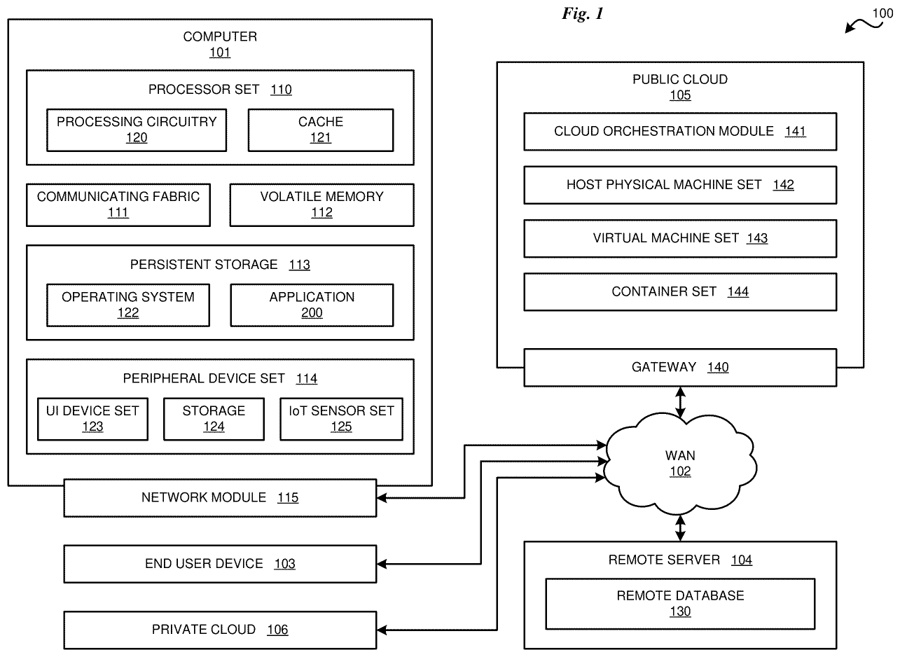

With reference to FIG. 1, this figure depicts a block diagram of a computing environment 100. Computing environment 100 contains an example of an environment for the execution of at least some computer code involved in performing the inventive methods, such as an example application 200 for attenuating hallucinations in large language models (LLM) using an agent-based perspectives, within a debate/critic-actor framework. The following are definitions for terms used throughout the disclosure. “Large language model” is a term used in the present disclosure to describe an artificial intelligence system designed to understand, generate, and manipulate language (e.g. human language); a “large language model” may be built on deep learning architectures, particularly neural networks, that are trained on vast amounts of text data to recognize patterns in language, allowing large language models to perform tasks like text generation, translation, summarization, and answering questions; “large language models,” such as OpenAI's Generative Pre-trained Transformer (GPT) or Google's Bidirectional Encoder Representations from Transformers (BERT), use billions of parameters to model the complexities of language, allowing large language models to generate coherent and contextually relevant responses; the term “large language model” may be used interchangeably with the terms “LLM” or “large language model (LLM)”; “personality” is term used in the present disclosure to describe a distinct style, perspective, point of view, or pattern of communication that a large language model (LLM) adopts when interacting with human users and agents (e.g., artificial users); a “personality” may encompass tone, word choice, sentence structure, and the overall approach to responding to queries, request or questions, reflecting specific traits such as formality, friendliness, experience, or humor; a “personality” of a large language model (LLM) (or adoption of a “personality”) may be implemented or deployed through the dynamic adjustment of the large language model (LLM)'s contextual embeddings, based on external inputs or predefined profile templates, predefined templates or profiles, to align the large language model (LLM)'s output with the desired communication style, without modifying large language model (LLM)'s underlying core architecture or neural network, allowing the large language model (LLM) to reinterpret queries and deliver responses that appear more formal, casual, assertive, or empathetic, based on the adjusted embedding patterns; alternatively, “personality” of large language model (LLM) (or adoption of a “personality”) may also be implemented or deployed through re-training or fine-turning the large language model (LLM)'s underlying core architecture or neural network to achieve the desired communication style; “profile” is a term used in the present disclosure to describe stored data, embedding or contextual embedding that represents predefined characteristics, attributes, or behaviors of a personality; “profile” may be can be templates or configurations that define how a particular personality operates or interacts when adopted by an agent, critic, or decision marker within a large language model (LLM); “embedding” is a term used in the present disclosure to describe a mathematical representation of data, typically in the form of a vector, that encodes the meaning or characteristics of an input (such as words, phrases, or entire sentences) in a way that allows a machine learning model or large language model to understand and work with the data (e.g., human text); an “embedding” may capture the relationships between words or concepts by placing the words or concepts in a continuous vector space, where words with similar meanings or usage patterns are positioned closer together; a “contextual embedding” is a term used in the present disclosure to describe a dynamic, vector-based representations of words, phrases, or tokens that capture meaning (of the words, phrases, or tokens) within a specific context or how the words, phrases, or tokens are used in a sentence; “profile” may contain the structured information that shapes a personality's actions, preferences, and decision-making processes before the “profile” becomes active or adopted in the large language model (LLM); the term “profile” may be used interchangeably with terms “predefined profile template,” or “template,” or “predefined template”; “adopt” or “adoption” is a term used in the present disclosure to describe a process or method by which a large language model, critic, or agent to takes on or assume a specific personality, such as, by loading a specific profile; when a large language model or agent “adopts” a personality, the large language model or agent may exhibit several characteristics, including: adapting or adjust language, tone, word choice, and sentence structure to match the desired personality traits, such as formality or friendliness; changing or modifying how the large language model or agent responds to queries or interacts with users (e.g., human and artificial) to align with the characteristics of the specific personality; and implementing or employing specific communication patterns and nuances associated with the specific personality; the term “adopt” may be used interchangeably with terms “manage,” “assume,” “set,” or “take on,” or “implement” or “register” or “load”; “agent” is a term used in the present disclose to describe an artificial entity, such as an artificial intelligence (AI) system, chatbot, software bot, or autonomous machine, that interacts with humans or other artificial entities; an “agent” may capable of performing tasks, making decisions, and engaging in communication based on the agent's programming or learned behaviors or underlying large language model (LLM) deployed or used by the agent; unlike humans, “agents” are designed to operate according to algorithms, rules, or machine learning models, contributing to a task or goal through automated or semi-automated actions and interactions; an “agent” may adopt a “personality” through the deployment or use of underlying large language model (LLM), which also adopts the “personality”; “critic” is a term used in the present disclosure to describe either a separate, specialized agent or a component within a large language model (LLM) or debate and critic-actor framework that evaluates and assesses the responses generated by agents or other components; the role of a “critic” is to review and challenge these responses of agents against factual information, predefined criteria, threshold, or contextual relevance; additionally, a “critic” may reprogram an agent with a different personality if necessary (e.g., agent is malfunctioning) or ask an agent to reconsider or engage in reflection or self-reflection; “critics” may help identify inaccuracies, inconsistencies, and potential hallucinations of a large language model (LLM) or agent by providing a thorough analysis of the outputs; for instance, “agents” may handle user queries or perform specific actions, while “critics” may be tasked with auditing the outputs of multiple agents or ensuring compliance with factual accuracy of a large language model (LLM); “decision maker” is a term used in the present disclosure to describe a specialized type of agent responsible for evaluating and selecting the most suitable response or synthesized solution based on the debate and analysis or debate and critic-actor framework conducted by other agents and critics; “decision maker” may synthesizes diverse inputs, including perspectives and critiques, and assesses them against predefined threshold to reach a final decision to conclude a debate or round; unlike agents that present or critics that challenge various viewpoints, the “decision maker” integrates these contributions of agents and critics and utilizes critical assessments to guide and arrive at a coherent and reliable conclusion on whether to end a debate or round, ensuring that the results align with the overall goals and constraints of the debate; “rules of debate” is a term used in the present to describe the limits or constraints placed on the operation or behavior of one or more agents or critics by the decision maker within the debate and critic-actor framework; for example, “rules of debate” may stipulate that agents (or critics) provide responses in a multiple-choice format, true/false, yes/no, or within a certain time period; “rules of debate” may also define parameters such as the number of rounds in a debate or the number of agents and/or critics participating in each round; “user's query” is a term used in the present disclosure to describe an input, topic, challenge, instruction, request, or question posed by the user to a large language model (LLM); “user's query” may serve as a basis for selecting agents, critics, decision markers, and constructing a personality council, guiding the large language model (LLM)'s response process; the term “user's query” may be used interchangeably with the term “topic” or “user input”; “answer” is a term used in the present disclosure to describe a final or intermediate output, or response (of a large language model (LLM) as a solution or information provided to address the user's query) presented to the user during or after the conclusion of debate process within the personality council; “answer” may be derived from the action-flow, which consists of one or more proposed actions generated by the agent(s) with the adopted personality, after being critiqued and refined by the critic(s), and overseen by decision maker(s); “hallucination” is a term used in the present disclosure to describe the generation of information that seems accurate or plausible but is, in fact, incorrect, erroneous, fabricated, or suboptimal; “hallucinations” may manifest as false facts, invented details, or misleading responses that are not grounded in reality or supported by the large language model's training data; “hallucinations” may occur because the large language model learning generates outputs based on learned patterns rather than verified facts or the underlying facts are undisputed; “hallucination” may arise due to limitations in the large language model's training data, inherent biases, or the probabilistic nature of text generation; “hallucinations” may be categorized into two types: factual hallucinations, where the model presents false information as fact (e.g., incorrect historical dates or nonexistent scientific concepts), and contextual hallucinations, where the large language model generates content that does not logically or meaningfully fit the context, such as misinterpreting a user's query or producing incoherent responses; “debate and critic-actor framework” is a term used in the present disclosure to describe an approach used to enhance the accuracy and reliability of large language models (LLMs) by integrating multiple perspectives (e.g., agents, critics, decision maker) in decision-making process of the large language models (LLMs). In “debate and critic-actor framework,” agents representing different personalities or viewpoints engage in a debate, presenting and challenging various responses to a given query; critics, either as separate specialized agents or components within large language models (LLMs), evaluate these agents'responses against factual information and predefined criteria; decision markers moderate or oversee the debate process; “debate and critic-actor framework” may follow this iterative process (conducted through one or more rounds) of debate and critical assessment allows for dynamic refinement and validation of outputs, leading to a more accurate, cohesive, and reliable result from the large language models (LLMs); “debate and critic-actor framework may conclude a round or the debate when a threshold is met or exceeded determined by a decision maker; the term “debate and critic-actor framework” may be used interchangeably with the terms “debate or critic-actor framework,” “critic-actor framework,” or “debate”; “personality council” is a term used in the present disclosure to describe an organization or data structure for managing, moderating, or overseeing agents, critics, and decision markers engaged in the debate and critic-actor framework; a “threshold” may serve as a standard, rule or benchmark for determining the conclusion (by a decision maker) of a debate or a round of debate within the debate and critic-actor framework; for example, an accuracy “threshold” might require that if the responses from agents are evaluated and a consensus or a majority of the critics (or agents) agree that a response of an agent or a consensus response meets a predefined accuracy level (e.g., 95% factual correctness), the debate may be concluded; similarly, a divergence “threshold” may mandate that the debate (or round) concludes if the responses from different agents converge or if the variability in agents' answers falls below a certain percentage, indicating that a consensus has been reached; Other examples of “thresholds” include a quality benchmark “threshold,” where the debate (or round) ends when the agents'responses achieve a quality score above a certain threshold, such as a specific rating from critics based on relevance, coherence, and completeness; a time limit “threshold” may require the debate (or round) concludes when a predetermined amount of time has elapsed, ensuring that the iterative process is efficient and does not drag on indefinitely; additionally, a criteria fulfillment “threshold” may require the debate (round) ends when agents'responses meet specific predefined criteria, such as addressing all critical aspects of the user query or fulfilling particular functional requirements or constraints; “action-flow” is a term used in the present disclosure to describe a sequence or series of steps or operations derived from proposed actions generated by agents, critics, decision markers, within or related to a debate and critic-actor framework; “action flow” may outline the specific actions or recommendations that result from deliberations, debates, or decision-making one or more agents, critics, decision markers, serving as, for example, a structured plan or roadmap guiding a user to next steps or outputs; the term “action-flow” may be used interchangeably with terms “action plan,” “action flow,” “plan,” “workflow,” “work-flow”; “deep learning techniques and algorithms” is a term used in the present disclosure to describe a set of advanced algorithms that may be employed by large language models (LLMs) including recurrent neural networks (RNNs), which process sequential data by incorporating feedback loops, long short-term memory (LSTM) networks, which manage long-term dependencies in sequences using specialized gates; transformers, which utilize self-attention mechanisms for efficient sequence processing and natural language tasks, generative adversarial networks (GANs), which involve a generator and a discriminator network competing to create realistic data samples; the term “deep learning techniques and algorithms” may be used interchangeably terms “deep learning algorithm” or “deep learning algorithms”; “natural language processing (NLP)” is a term used in the present disclosure to describe a branch of artificial intelligence focusing on permitting computers to understand, interpret, and generate human language; “natural language processing (NLP)” may involves various tasks such as text analysis to extract information, speech recognition to convert spoken language into text, and language generation to produce coherent responses, as used by large language models (LLMs); “natural language processing (NLP)” may use techniques such as named entity recognition for identifying key entities in text, sentiment analysis for assessing emotional tone, and intent classification for understanding user intentions;

In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

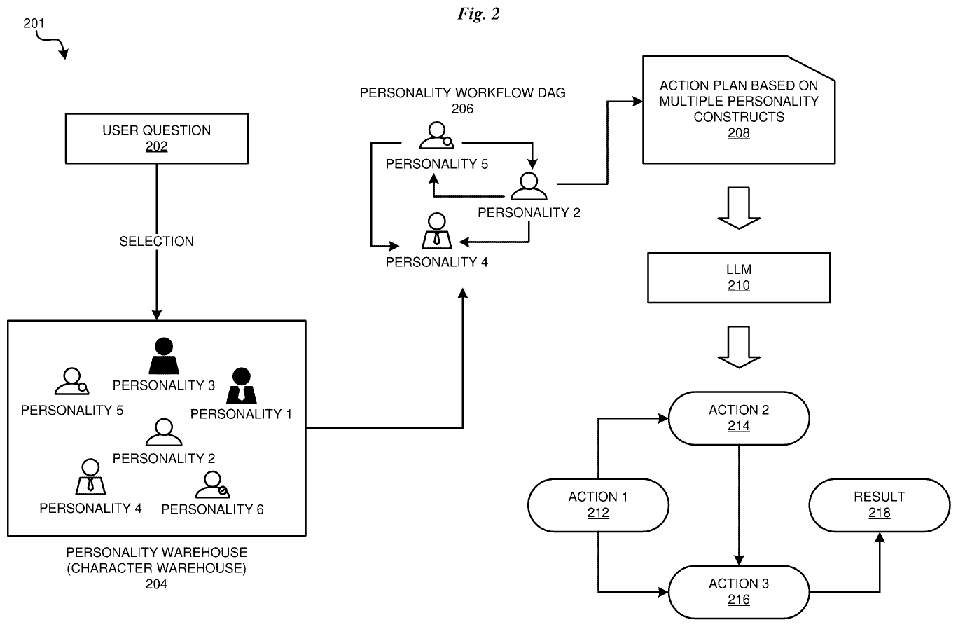

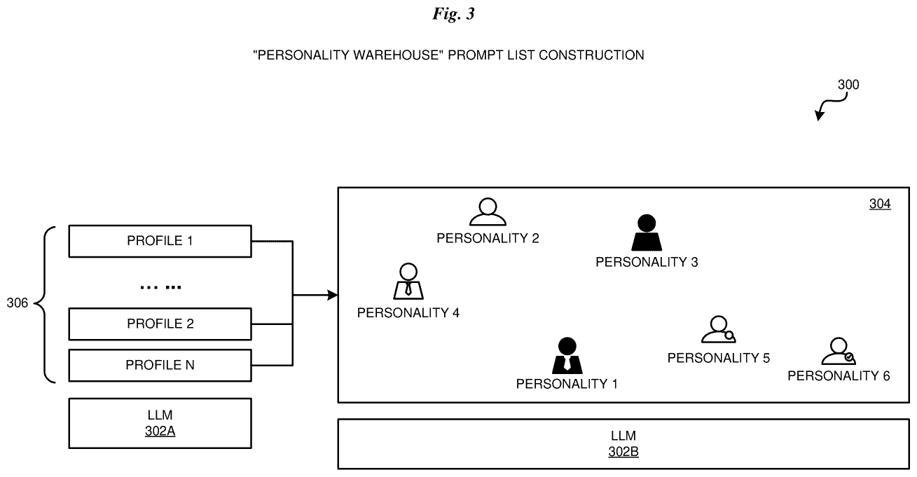

With reference to FIG. 2, this figure depicts block diagram 201, which provides an agent-based perspective within a debate or critic-actor framework, deployed alongside a large language model (LLM), in accordance with an illustrative embodiment. In the illustrated embodiment, block diagram 201 includes a one or more of the following components: user question component 202, personality warehouse (character warehouse) component 204, personality workflow distributed action generator (DAG) component 206, action plan based on multiple personality constructs component 208, large language model (LLM) component 210, and a set of action components: action 1 component (212), action 2 component (214), action 3 component (216), and result 218 component. Components of FIG. 2 shall be further described below and in subsequent FIGS. 3-5 .

User question component 202 receives a user's query or input by computer user interface (e.g., user interface (UI) device set 123), generally in the form of a textual query, question, request or statement. In some embodiments, user question component 202 may be implemented as dynamic prompt interface, which enables the creation, adjustment, and optimization of prompts (e.g., a user queries) in real-time. In some embodiments, user question component 202 may select one or more personalities from the personality warehouse (character warehouse) 204 for adoption by large language model (LLM) component 210, based on the user-query. In other embodiments, a list of available personalities (e.g., prompt list of personalities) may be presented to a user through a computer user interface (e.g., user interface (UI) device set 123), based on the user's query.

Personality warehouse (character warehouse) component 204 acts as a repository for personalities. In some embodiments, personality warehouse (character warehouse) component 204 includes at least two pre-configured, system-defined personalities (e.g., personality 2, personality 4, personality 5, and personality 6) and supports an unlimited number of customizable personalities (e.g., personality 1, and personality 3) tailored to the needs of the end-clients and users. Additionally, in other embodiments, pre-configured and custom personalities are created based on predefined profile templates. Based on the input from user question component 202, one or more personalities are selected from personality warehouse (character warehouse) component 204 and provided to the personality workflow distributed action generator (DAG) component 206 as input. In some embodiments, personality workflow distributed action generator (DAG) component 206 may also handle the selection of personalities from personality warehouse (character warehouse) component 204, based on the input from user question component 202.

Personality workflow distributed action generator (DAG) component 206 uses personality warehouse (character warehouse) component 204 to enhance the performance of large language model (LLM) component 210, such as reducing hallucinations, for specific tasks aimed at achieving a user's goal (e.g., assigning or distributing user queries to a workflow or action plan for processing or execution by one or more selected personalities, managed by one or more agents or LLMs). Personality workflow distributed action generator (DAG) component 206 may receive inputs from and provide outputs to other components as well as, coordinating with Action plan based on multiple personality constructs component 208, when multiple personalities are deployed through agents.

Action plan based on multiple personality constructs component 208 may assist in overseeing or managing the collaboration among multiple personalities, either through agents or large language model (LLM) component 210, as the personalities contribute to analyzing user query received through user question component 202. This collaboration process may involve one or more rounds of interaction and debate among the multiple personalities (who may be represented through agents or LLM) and potentially critics (who may be represented through specialized agents or LLM). Action plan based on multiple personality constructs component 208 receives inputs, such as the user's query, selected personalities (including profiles, designed roles) and data from the one or more of selected personalities. These inputs are processed and provided to agents or large language model (LLM) component 210, which the agents or large language model (LLM) component 210 executes actions (e.g., action 1 component (212), action 2 component (214), action 3 component (216), and result 218 component) based on the adopted multiple personalities to generate distinct, harmonized, or synthesized analysis as outputs. The outputs of agents or large language model (LLM) component 210 are consolidated (by action plan based on multiple personality constructs component 208) and comprehensive report, potentially integrating, individual personality analysis and synthesized analysis, may be provided to the user.

Large language model (LLM) component 210 implements a large language model designed to receive and response to user queries. Large language model (LLM) component 210 may receive input directly or indirectly from user question component 202, personality workflow distributed action generator DAG component 206, or action plan based on multiple personality constructs 208 component or in agents or critics. Large language model (LLM) component 210 may adapted to adopt one or more personalities based on the selection of personality workflow distributed action generator (DAG) component 206. Large language model (LLM) component 210 may service one or more of these personalities in a round-robin fashion or other methods known to those skilled in the art. Large language model (LLM) component 210 executes actions based on the adopted personalities or agents, generating either distinct analyses from each personality or a synthesized analysis combining insights from multiple personalities. The results of large language model (LLM) component 210 are output in a format that aligns with the requirements of set of action components: action 1 component (212), action 2 component (214), action 3 component (216), and result 218 component. The set of action components may specify the actions or responses provided by the personalities (through agents or LLM), and the result 218 component may consolidate these actions into a cohesive and comprehensive report, synthesizing the diverse analysis into a unified, actionable summary for the user.

Still referring to FIG. 2, consider a scenario where one personality (functioning as an agent) is used to process a user query. When a user submits a query through user question component 202 to analyze of a specific company's business model (e.g. IBM), personality workflow distributed action generator (DAG) component 206 references or consults a personality prompt list within personality warehouse (character warehouse) component 204. Personality warehouse (character warehouse) component 204 includes a pre-configured personality (e.g., personality 2) tailored for business analysis. Personality 2 is characterized as “a business analyst with 20 years of experience, familiar with the analytical models of the business model canvas (e.g., tool used to visually represent and develop a company's business model), and knowledgeable about the business models of well-known companies” as part of a basic description. Beyond the basic description, the profile for Personality 2 may also include: goal (e.g., “analyze and evaluate the business model of a specified company”), constraints or limitations (e.g., “only provides information available in a particular database and not providing unknown information”), skills or abilities (e.g., “familiar with the analytical models of the business model canvas and knowledgeable about the business models of well-known companies”), or workflow or behavior (e.g., “a) The user inputs a company name. b) personality 2 analyzes and evaluates the company using the business model canvas, outputting the thought process for each module. c) outputs the complete business model canvas”).

Personality workflow distributed action generator (DAG) component 206 then selects personality 2 (to function as an agent), equipped with relevant attributes, skills and experience (e.g., utilizing the business model canvas and applying the personality's knowledge of various company business models), to analyze and evaluate the designated company's business model.

Once personality workflow distributed action generator (DAG) component 206 select personality 2, large language model (LLM) component 210 adopts personality 2 or personality 2 is integrated with or adopted by an agent. It should be noted that, in the examples provided below, the terms “Personality #” (e.g., personality 2, and personality 4) refer to specific personalities functioning as an “agent”or being adopted by a Large Language Model (LLM).

Personality 2's analysis operates (through a LLM or agent) within specified constraints and user's goals, such as only providing information available in a particular database (e.g., a database used to train the large language model (LLM) component 210) and not offering information beyond the database's scope.

Additionally, personality 2 (e.g., through an agent or LLM) performs a series of operations according to its specified workflow/behavior: first, personality 2 (e.g., through an agent or LLM) receives the user's input regarding the company to be analyzed. Next, personality 2 (e.g., through an agent or LLM) uses the business model canvas framework to analyze and evaluate the company, detailing its thought process for each component of the canvas. Finally, personality 2, through large language model (LLM) component 210, generates and presents a complete business model canvas based on the analysis. This example illustrates a process for ensuring that large language model (LLM) component 210 provides a coherent and contextually relevant business analysis by leveraging the attributes and workflows of predefined personality in accordance with illustrative embodiments.

Referring again to FIG. 2, consider a scenario where multiple personalities (functioning as agents) are used to process a user query. When a user submits a query requesting a comprehensive business analysis of a new startup company, personality workflow distributed action generator (DAG) component 206 takes charge of managing the response process for large language model (LLM) 210. User query component 202 captures the query, and personality workflow distributed action generator (DAG) component 206 references the personality prompt list within personality warehouse (character warehouse) component 204 to select the most suitable personalities for the task (e.g., user query)

Under this scenario, personality workflow distributed action generator (DAG) component 206 selects three specific personalities to meet the user's needs: personality 5, an expert in market trends; personality 4, a specialist in competitive analysis; and personality 2, a business model analyst. Each personality, represented through an agent or LLM, is assigned a distinct role in an action plan (e.g., action plan based on multiple personality constructs 208) designed to deliver a comprehensive analysis for the user. Additionally, in some embodiments, each personality (whether functioning as an agent or integrated within the LLM) may interact with other personalities and engage in self-reflection, considering and reassessing the personality's outputs based the feedback from other personalities, critics, or new user input or information.

Action plan based on multiple personality constructs component 208 begins with personality 5, who focuses on analyzing market trends relevant to the startup's industry. Personality 5 collects and examines data on current industry trends, identifies key opportunities and threats, and summarizes these insights to provide a thorough overview of the market landscape to the other personalities.

Next, personality 4 conducts a competitive analysis. This personality identifies major competitors, assesses their strengths and weaknesses, and compares them with the new startup company's offerings. Personality 4 then provides a summary of the competitive environment to highlight the new startup company's positioning within the market. Following personality 4's actions, personality 2 evaluates the new startup company's business model using a business model canvas framework (e.g., management tool that provides a visual framework for developing, describing, and analyzing a business model). Personality 2 inputs the new startup company's information into the business model canvas framework, analyzes each component (e.g., as key partners, key activities, value propositions, customer segments, and revenue streams), and generates a detailed business model canvas for the new startup company based on this analysis.

In some embodiments, personality workflow distributed action generator (DAG) component 206 then integrates the outputs from all selected personalities (e.g., personality 2, personality 4, and personality 5). This integration may involve combining the market trends analysis, competitive analysis, and business model evaluation into a cohesive report for the user. Insights gleaned from the cohesive report may be further reviewed and refined to ensure clarity and completeness. In other embodiments, large language model (LLM) component 210 may integrate the outputs from all selected personalities (e.g., personality 2, personality 4, and personality 5).

Finally, in some embodiments, large language model (LLM) component 210, guided by the synthesized or integrated insights from personality 5, personality 4, and personality 2, generates and presents the comprehensive business analysis report to the user. The report includes all findings in a unified format, delivering a thorough and actionable analysis (e.g., action 2 component (214), action 1 component (212), action 3 component (216), result component 218 of the new startup company.

Referring to FIG. 3, this figure depicts block diagram 300 for a personality warehouse prompt list construction in accordance with an illustrative embodiment. It should be noted that personality warehouse (character warehouse) component 304 may be regarded as an instance of personality warehouse (character warehouse) component 204 and large language model (LLM) component 210 may be regarded as instances of large language model (LLM) component of 302a-b mentioned earlier. In the illustrated embodiment, block diagram 300 includes profiles 1-N components 306, large language model (LLM) component 302a-b, and personality warehouse 304 component.

Profiles 1-N component 306 represent stored data or contextual embeddings (e.g., a profile or predefine profile template) for one or more personalities available to the large language model (LLM) component 302a, such as those listed in a personality warehouse prompt list (e.g., user interface (UI) device set 123). It should further be appreciated that large language model (LLM) component 302a refers to the state of the large language model (LLM) before personalities are adopted by agents or critics. After loading or registering the profiles (e.g., profiles 1-n component 306), the large language model (LLM) transitions to the state shown in FIG. 3 as large language model (LLM) component 302b, where the personalities (e.g., personality 1, personality 2, personality 3, personality 4, personality 5, and personality 6) have been adopted, executing within respective agents or critics within large language model (LLM) component 302b. In FIG. 3, profile 1 corresponds to personality 1, profile 2 to personality 2, profile 3 to personality 3, and so on. Additionally, the key distinction between profiles 1-N component 306 in large language model (LLM) component 302a and the personalities (e.g., personality 1, personality 2, personality 3, personality 4, personality 5, and personality 6) in personality warehouse component 304 is that the personalities in personality warehouse component 304 have been adopt by one or more agents or critics, being actively multiplexed or executed within large language model (LLM) component 302b. personality 3 and personality 1 are highlighted in bold to indicate their active or selected status within large language model (LLM) component 302b.

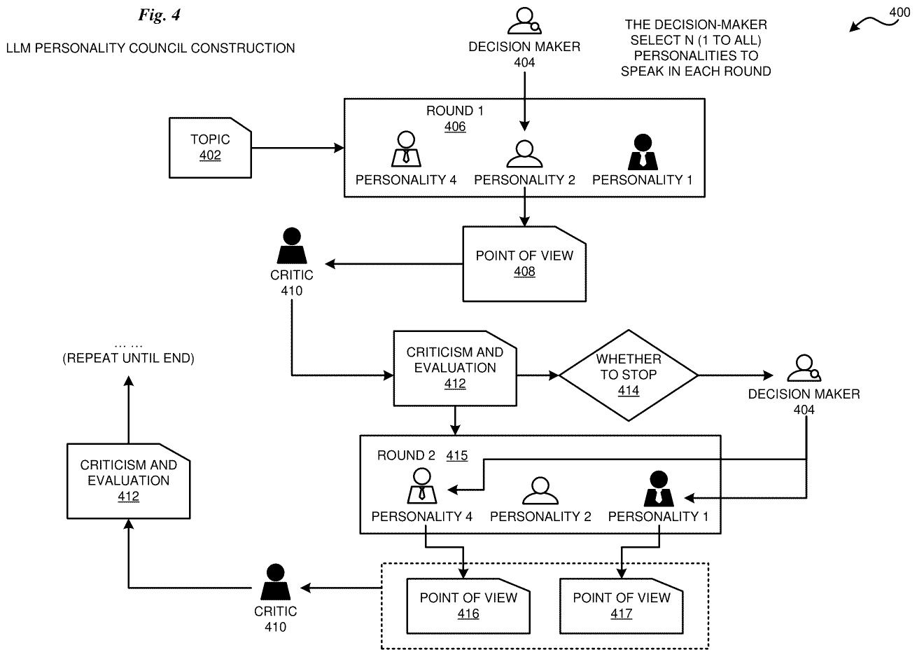

With reference to FIG. 4, this figure depicts flowchart 400 of LLM Personality Council Construction in accordance with an illustrative embodiment. It should be noted that personality workflow distributed action generator (DAG) component 206 may be regarded as an instance of LLM Personality Council Construction 400. In the illustrated embodiment, flowchart 400 includes decision maker component 404, round 1 component 406, topic component 402, point of view component 408, critic component 410, criticism and evaluation component 412, whether to stop component 414, round 2 component 415, point of view component 416, and point of view component 414.

Additionally, it should be noted that, provided below, the terms “Personality #” (e.g., personality 2, and personality 4) refer to specific personalities functioning as an “agent” or being adopted by a Large Language Model (LLM).

Still referring to FIG. 4, decision maker component 404 is delegated the responsible in this personality council to moderate at least a two-round debate between personalities 1, 2, 4. Decision maker component 404 may select up to N personalities (1 to all) (but in illustrated three personalities (e.g. personalities 1, 2, 4) are selected) to “speak,” engage, or participate in the one or more rounds of debate. Topic component 402 (e.g., user's query) is provided to at least one of the selected personalities 4, 2, 1. In round 1 component 406, personality 2 outputs or provides a response (e.g., point of view component 408). Point of view component 408 (encapsulating personality 2's response) is submitted to critic component 410. In criticism and evaluation component 412, critic component 410 questions or critiques point of view component 408 provided by personality 2.

In some embodiments, the results of criticism and evaluation component 412 are feed directly into round 2 component 415, as a new or refined or unmodified topic for debate. Alternatively, the results of criticism and evaluation component 412 are evaluated against one or more thresholds (e.g., 95% factual correctness) in whether to stop component 414 (by decision marker component 404) to determine whether to conclude the debate after round 1 (e.g., round 1 component 406) or proceed to round 2 (e.g., round 2 component 415). If the threshold(s) are not met or exceeded, decision maker component 404 initiates round 2 (e.g., round 2 component 415), submitting one or more of the following: topic component 402, threshold(s), and results from criticism and evaluation component 412 to personalities 4 and 1. Personality 4 provides a response (e.g., point of view component 416), and personality 1 provides a response (e.g., point of view component 417). Both responses are then fed back into critic component 410 for further consideration in criticism and evaluation component 412 (as well as by components 414 and 404), until the debate is repeated or concluded. Although a two-round debate described above were described in a specific order, it should be understood that other rounds of debate (including with one or more decision makers, critics, personalities) may be performed among the two-round debate or may be performed in an order other than that described, or rounds may be adjusted so that they occur at slightly different times. For example, a third round of debate may involve different critic(s) and decision maker(s) compared to those in the first and second rounds.

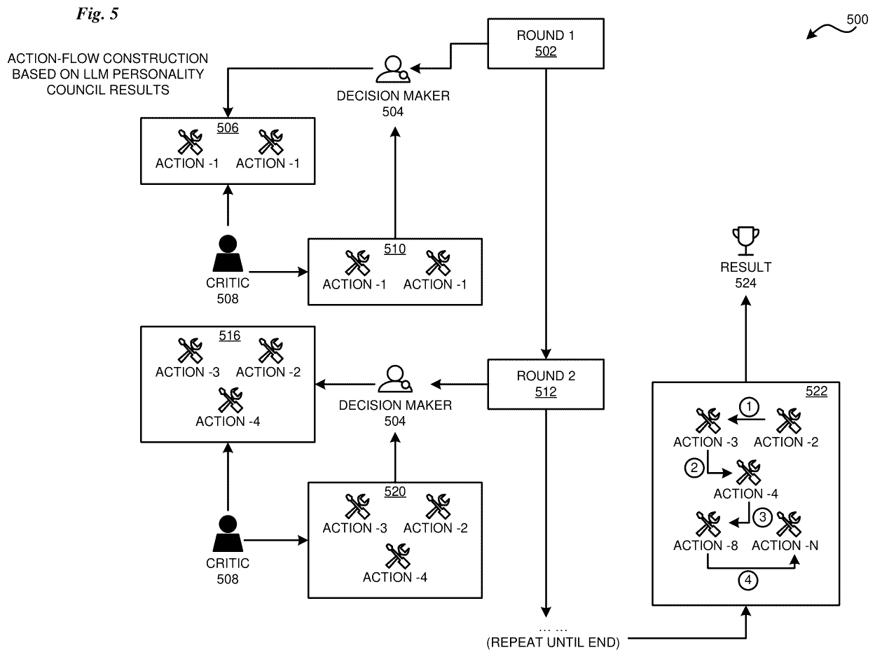

With reference to FIG. 5, this figure depicts a flowchart 500 of an action-flow construction based on LLM personality council results in accordance with an illustrative embodiment. It should be noted that action plan based on multiple personality constructs component 208 may be regarded as an instance of action-flow construction based on LLM Personality Council 500. Additionally, the actions and result components (e.g., 214, 212, 216, 218) may be considered instances of the actions and result components (e.g., 506, 510, 516, 520, 522, 524). Furthermore, flowchart 500 operates in conjunction with flowchart 400, where flowchart 500 depicts the intermediate or results or answers in action and results components (e.g., 506, 510, 516, 520, 522, 524) derived from one or more rounds of debate, while flowchart 400 illustrates the collaboration among the decision marker, critics, and personalities acting as agents. Consequently, round components (e.g., 502, 512) may be seen as instances of round components (e.g., 406, 415), decision marker component 504 may be considered as an instance of decision marker component 404, and critic component 508 may be viewed an instance of critic component 410. In the illustrated embodiment, includes one or more of the following components: round 1 component 502, round 2 component 512, decision maker component 504, critic component 508, action component 506, action component 510, action module 516, action component 520, action component 522, and result component 524.

Still referring to FIG. 5, decision maker component 504 is tasked with moderating a minimum of a two-round debate. Results from Round 1, as processed by round 1 component 502, are provided to decision maker component 504. Decision maker component 504 then forwards the results to action module 506 for possible display or answer, describing two actions a user or agent(s) may be suggested to take (e.g., action-1 and action-1). In the illustrated embodiment, critic module 508 reviews action module 506 and accepts results of action module 506 or provides feedback regarding action module 506 as output in action component 510. Additionally, decision maker component 504 may also review the output of action component 510, based on critic component 508 feedback.

Results from Round 2, processed by round 2 component 512, are then submitted to decision maker component 504. Decision maker component 504 forwards these results to action module 516 for possible display, as three actions (e.g., action-3, action-2, action-4) a user or agent(s) may be suggested to take. In the illustrated embodiment, critic module 508 reviews action module 516 and accepts results of action module 516 or provides feedback regarding action module 516 as output in action component 520. Additionally, decision maker component 504 may also review the output of action component 520, based on critic component 508 feedback.

This process of flowchart 500 is repeated as long as the debate continues. Action component 522 illustrates the final actions, and result component 524 represents the final results. Although a two-round debate described above were described in a specific order, it should be understood that other rounds of debate (including with one or more decision makers, critics, personalities) may be performed among the two-round debate or may be performed in an order other than that described, or rounds may be adjusted so that they occur at slightly different times. For example, a third round of debate may involve different critic(s) and decision maker(s) compared to those in the first and second rounds.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration. ” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection. ” References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method for attenuating hallucinations in a large language model (LLM), the method comprising:
selecting at least one agent and at least one critic from a plurality of agents and critics, based on a user's query;
constructing a personality council for the large language model (LLM) based on the user's query and the at least one agent and at the least one critic from the plurality of agents and critics, wherein the personality council instructs the least one agent to adopt a personality;
conducting one or more rounds of a debate, within the personality council, among the at least one agent and at the least one critic from the plurality of agents and critics, wherein a response of the least one agent with the adopted personality is critiqued by the least one critic, based on the user's query, until a threshold for concluding the debate is met or exceeded; and
building an action-flow comprised of one or more proposed actions derived from the response of the least one agent with the adopted personality engaged in the debate, within the personality council.

2. The method of claim 1, further comprising:
displaying an answer based the action-flow.

3. The method of claim 2, wherein: the selecting at least one agent includes selecting three agents and the personality council instructs the three agents to adopt distinct personalities.

4. The method of claim 3, wherein: the constructing the personality council for the large language model (LLM) is further based on a selection of at least one decision maker.

5. The method of claim 4, wherein: constructing the personality council for the large language model (LLM) further comprises: the personality council instructing the decision maker to moderate a debate.

6. The method of claim 5, wherein: the conducting the one or more rounds of the debate, within the personality council further comprises: concluding a round of a debate when a second threshold is met or exceeded.

7. The method of claim 3, wherein: the conducting the one or more rounds of the debate, within the personality council further comprises: concluding a round of the debate when a second threshold is met or exceeded.

8. A computer usable program product comprising one or more computer readable storage media, and program instructions collectively stored on the one or more computer readable storage media, the program instructions executable by a processor to cause the processor to perform operations attenuating hallucinations in a large language model (LLM) comprising:
selecting at least one agent and at least one critic from a plurality of agents and critics, based on a user's query;
constructing a personality council for the large language model (LLM) based on the user's query and the at least one agent and at the least one critic from the plurality of agents and critics, wherein the personality council instructs the least one agent to adopt a personality;
conducting one or more rounds of a debate, within the personality council, among the at least one agent and at the least one critic from the plurality of agents and critics, wherein a response of the least one agent with the adopted personality is critiqued by the least one critic, based on the user's query, until a threshold for concluding the debate is met or exceeded; and
building an action-flow comprised of one or more proposed actions derived from the response of the least one agent with the adopted personality engaged in the debate, within the personality council.

9. The computer usable program product of claim 8, further comprising:
displaying an answer based the action-flow.

10. The computer usable program product of claim 9, wherein: the selecting at least one agent includes selecting three agents and the personality council instructs the three agents to adopt distinct personalities.

11. The computer usable program product of 10, wherein: the constructing the personality council for the large language model (LLM) is further based on a selection of at least one decision maker.

12. The computer usable program product of 11, wherein: constructing the personality council for the large language model (LLM) further comprises: the personality council instructing the decision maker to moderate a debate.

13. The computer usable program product of claim 12, wherein: the conducting the one or more rounds of the debate, within the personality council further comprises: concluding a round of a debate when a second threshold is met or exceeded.

14. The computer usable program product of claim 10, wherein: the conducting the one or more rounds of the debate, within the personality council further comprises: concluding a round of the debate when a second threshold is met or exceeded.

15. A computer system comprising a processor and one or more computer readable storage media, and program instructions collectively stored on the one or more computer readable storage media, the program instructions executable by the processor to cause the processor to perform operations attenuating hallucinations in a large language model (LLM) comprising:
selecting at least one agent and at least one critic from a plurality of agents and critics, based on a user's query;
constructing a personality council for the large language model (LLM) based on the user's query and the at least one agent and at the least one critic from the plurality of agents and critics, wherein the personality council instructs the least one agent to adopt a personality;
conducting one or more rounds of a debate, within the personality council, among the at least one agent and at the least one critic from the plurality of agents and critics, wherein a response of the least one agent with the adopted personality is critiqued by the least one critic, based on the user's query, until a threshold for concluding the debate is met or exceeded; and
building an action-flow comprised of one or more proposed actions derived from the response of the least one agent with the adopted personality engaged in the debate, within the personality council.

16. The computer system of claim 15, further comprising:
displaying an answer based the action-flow.

17. The computer system of claim 16, wherein: the selecting at least one agent includes selecting three agents and the personality council instructs the three agents to adopt distinct personalities.

18. The computer system of claim 17, wherein: the constructing the personality council for the large language model (LLM) is further based on a selection of at least one decision maker.

19. The computer system of claim 18, wherein: constructing the personality council for the large language model (LLM) further comprises: the personality council instructing the decision maker to moderate a debate.

20. The computer system of claim 19, wherein: the conducting the one or more rounds of the debate, within the personality council further comprises: concluding a round of a debate when a second threshold is met or exceeded.
